(19) United States
(12) Patent Application Publication
(10) Pub. No.: US 2013/0111711 A1
(43) Pub. Date: May 9, 2013

(54) INTERLOCKING KEY ATTACHMENT TAB AND METHOD OF USE

(71) Applicant: Andreas Haase, Park City, UT (US)

(72) Inventor: Andreas Haase, Park City, UT (US)

(21) Appl. No.: 13/288,283

(22) Filed: Nov. 3, 2011

(51) Int. Cl. F16B 1/00

(52) U.S. Cl. 24/307; 24/593.1

(57) ABSTRACT

The present invention relates generally to an attachment tab, and more specifically, to an interlocking key attachment tab designed to provide a structurally sound and secure attachment point for electronics covers and cases made from flexible elastomeric material, plastic or similar structural material.

### BACKGROUND OF THE INVENTION

The present invention relates generally to an attachment tab, and more specifically, to an interlocking key attachment tab designed to provide a structurally sound and secure lanyard attachment point for electronics covers and cases made from flexible elastomeric material, plastic or similar structural material.

In today's electronically connected world, cell phones and moreover smart-phones are largely ubiquitous and, the users of these devices, are constantly looking for aftermarket covers to protect their investment, distinguish their device from others, and to express their own personality through customization. There are a number of aftermarket covers, made from various material including, fabric, leather, metal, plastic and elastomeric materials, such as, vinyl, silicone or rubber. Each of the materials has different aesthetic appeal and provides varying degrees of protection for the device. However, the type of protective case used, will largely be determined by costumer preference.

Some users may prefer the additional security of attaching a leash or lanyard to the protective case. The leash or lanyard may be a wrist strap to protect the device from falls or the user may prefer to carry a device on a neck lanyard versus in a purse or pocket.

A lanyard attachment point can be formed into most protective cases, however, it is desirable to create a lanyard attachment point that does not substantially extend beyond the protective case envelope, does not create a pressure point or source of discomfort for the user and is a secure feature of the protective case. When a lanyard attachment point is formed into an elastomeric protective case, additional material thickness must be added to prevent the lanyard attachment point from tearing out of the soft and pliable material.

What is needed is a lanyard attachment point that can be formed into an electronic protective case that does not extend beyond the protective case envelope, does not create any user discomfort, and is a secure attachment point, even for protective cases made using an elastomeric material.

### SUMMARY OF THE INVENTION

A first embodiment of the present invention is an interlocking key attachment tab with a corresponding socket formed into a planner base material. The attachment tab formed as a planner object or showing a thin vertical profile, having a body portion and a protruding tab portion. The body portion having, a first size and shape and the protruding ztab having a second size and shape, smaller than the size of the body portion. The protruding tab including, a neck portion and an attachment end; the neck portion and the attachment end, narrower than the body portion. In one embodiment, the tab portion is less than 10 percent narrower than the body portion, in another embodiment, the tab portion is 10 percent narrower than the body portion, in another embodiment, the tab portion is 20 percent narrower than the body portion, in another embodiment, the tab portion is 30 percent narrower than the body portion, in another embodiment, the tab portion is 40 percent narrower than the body portion, in another embodiment, the tab portion is 50 percent narrower than the body portion, in yet another embodiment, the tab portion is greater than 50 percent narrower than the body portion. The attachment end having an attachment hole formed through the planner material.

The corresponding socket formed into a first side of the planner base material, the socket depth equal to or greater than the thickness of the attachment tab. The socket formed having, a size and shape configured to correspond with the body portion of the attachment tab. The socket including a slot opening formed into a vertical surface, allowing the tab portion to be extended through to a second side of the base material.

The body portion of the attachment is installed into the socket on the first side of the planner material, with the tab portion placed through the socket opening, allowing the tab potion, with the attachment hole, to be exposed on the second side of the planner material. This configuration creates an attachment tab that extends to a second side of a planner material, that is secure and having a thin profile. When a load is applied the to the attachment tab, this configuration directs the load parallel to the surface of the planner material, distributing the pressure across a large area, and reducing the potential for base material or attachment tab failure. Where the planner material is an elastomeric material, such as, vinyl, rubber or silicone; the relatively soft and pliable material has a propensity to tear when an attachment tab is formed directly into the material. Whereas, when a durable material attachment tab is interlocked into the elastomeric material, the potential for failure due to tearing is greatly reduced.

One embodiment of the present invention is an interlocking key attachment tab with a corresponding socket including one or more shear lugs formed into the planner base material. The interlocking key attachment tab, having a body potion and attachment tab portion, the body portion having one or more cut-away areas or holes, the cut-away areas or holes having a distinct shape, a corresponding socket formed into a first side of a planner base material, a slot is formed in the vertical wall of the socket, and one or more shear lugs having the distinct shape of the cut-away areas or holes formed on the bottom surface. When the interlocking key attachment tab is inserted into the corresponding socket, the attachment tab portion is extended through the slot formed in the vertical wall of the socket; the attachment tab extending to the second side of the planner base material, the body portion is pressed into the corresponding socket with shear lugs engaged into the cut-away areas or holes in the attachment tab body portion. The shear lugs providing additional shear force distribution when the attachment tab is under load.

In one embodiment of the present invention, the body portion of the interlocking key attachment tab is configured as a unique or customizable shape. The shape of the body portion can vary, as long as, the width of the body portion is larger than the width of the neck portion of the attachment tab and the corresponding slot in the vertical wall of the socket. It is contemplated that the shape of the body portion can be, but is not limited to, an oval, circle, square, rectangle, diamond, triangle, pentagon, hexagon, octagon, heart, spade, clover, or other customizable shape as envisioned or requested by a second party or customer. It is contemplated that the body portion can be printed with a distinct pattern or can be embossed or include a pattern.

In yet another embodiment of the present invention, the interlocking key attachment tab includes a body portion and an attachment portion. The body portion formed from a first planner material and the attachment portion formed from a second cable or cordage type material. The attachment portion can be joined with the body portion by overmolding, adhesive or by mechanical means. It contemplated that the attachment portion can be formed using, but limited to, a loop of, stainless steel cable, nylon monofilament, nylon cordage and woven fiber such as Kevlar®. Additionally, it is contemplated that the attachment portion is configured as a releasable buckle, clip or a break-away assembly as commonly known in the art.

The above embodiments disclose using an interlocking key attachment tab in conjunction with a corresponding socket formed into planner base material. It contemplated that the planner base material, may be, but is not limited to, a plastic, nylon, vinyl, silicone, a metal, such as, aluminum, titanium, stainless steel or a composite such as fiberglass, graphite or Kevlar®.

These and other features and advantages of the disclosure will be set forth and will become more fully apparent in the detailed description that follows and in the appended claims. The features and advantages may be realized and obtained by the instruments and combinations particularly pointed out in the appended claims. Furthermore, the features and advantages of the disclosure may be learned by the practice of the methods or will be obvious from the description, as set forth hereinafter.

### BRIEF DESCRIPTION OF DRAWINGS

The following description of the embodiments can be understood in light of the Figures, which illustrate specific aspects of the embodiments and are part of the specification. Together with the following description, the Figures demonstrate and explain the principles of the embodiments. In the Figures the physical dimensions of the embodiment may be exaggerated for clarity. The same reference numerals in different drawings represent the same element, and thus their descriptions may be omitted.

FIG. 1 illustrates a perspective view of an interlocking key attachment tab with a corresponding socket;

FIG. 2 illustrates a perspective view of an interlocking key attachment tab engaged in a corresponding socket;

FIG. 3A illustrates top view of an interlocking key attachment tab with the body portion visible on the first side of the planner base material;

FIG. 3B illustrates bottom view of an interlocking key attachment tab with the attachment tab portion visible on the second side of the planner base material;

FIG. 4A illustrates a first embodiment of the interlocking key attachment tab;

FIG. 4B illustrates another embodiment of the interlocking key attachment tab having a second shape;

FIG. 4C illustrates another embodiment of the interlocking key attachment tab having a third shape, and;

FIG. 4D illustrates another embodiment of the interlocking key attachment tab having a cable or cordage attachment portion.

### DETAILED DESCRIPTION OF THE INVENTION

For the purposes of promoting an understanding of the principles in accordance with the disclosure, reference will be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure.

As used in this specification and the appended claims, the singular forms “a,” “an,” and “the” include plural referents unless the context clearly dictates otherwise. In describing and claiming the present disclosure, the following terminology will be used in accordance with definitions set out below. As used herein, the terms “comprising,” “including,” “containing,” “characterized by,” and the grammatical equivalents thereof are inclusive or open-ended terms that do not exclude additional, unrecited elements or method processes.

The disclosure relates to an interlocking key attachment tab, in particular, the disclosure relates to an interlocking key attachment tab and a corresponding socket formed into a planner base material. The apparatus may be used to create an attachment point in a planner base material and may be especially useful where the base material does not have the desirable material attributes of strength and shear resistance.

An interlocking key attachment tab is a mechanical tab fabricated from a suitable material to resist stretch and breakage.

A socket is a formed recess or receptacle designed to receive and retain an engaging component or interlocking key.

Planner base material is thin material that may be described as sheet material.

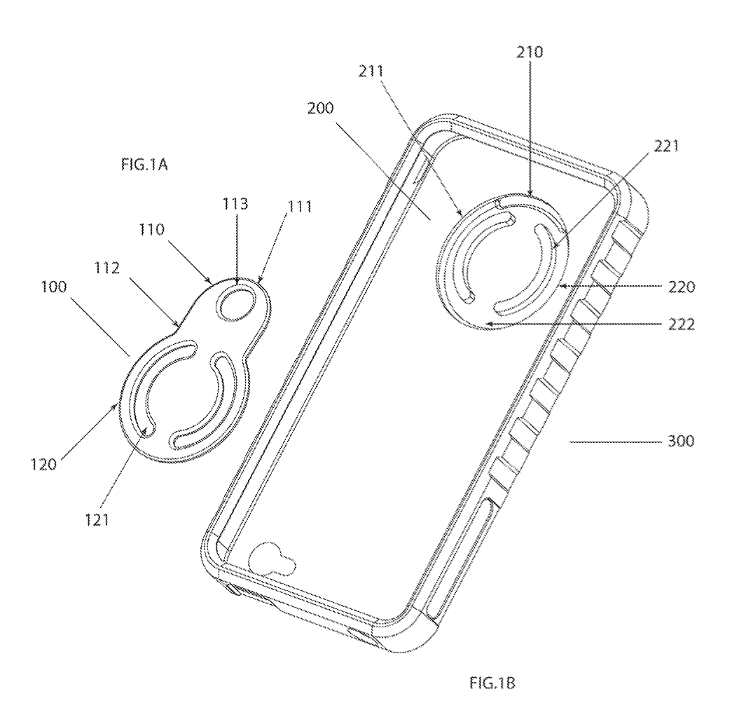

Illustrated in FIG. 1, is a perspective view of an interlocking key attachment tab 100, having a body portion 120 and attachment portion 110. The attachment portion 110, including, an attachment end 111 and neck portion 112; an attachment hole 113 formed in the attachment end 111. The body portion 120 having a first size and shape, the attachment portion 110 having a second size and shape, smaller than the size of the body portion 120. The body portion including shear lug openings 121.

A socket 200, corresponding in size and shape of the body portion 120 is formed into a planner base material 300; in the present example, the planner material is the back portion of a smart phone protective cover. Socket 200 including a slot 210 formed into the vertical wall 211 of the socket 200 and shear lugs 221 formed on the bottom surface 222 of socket 200.

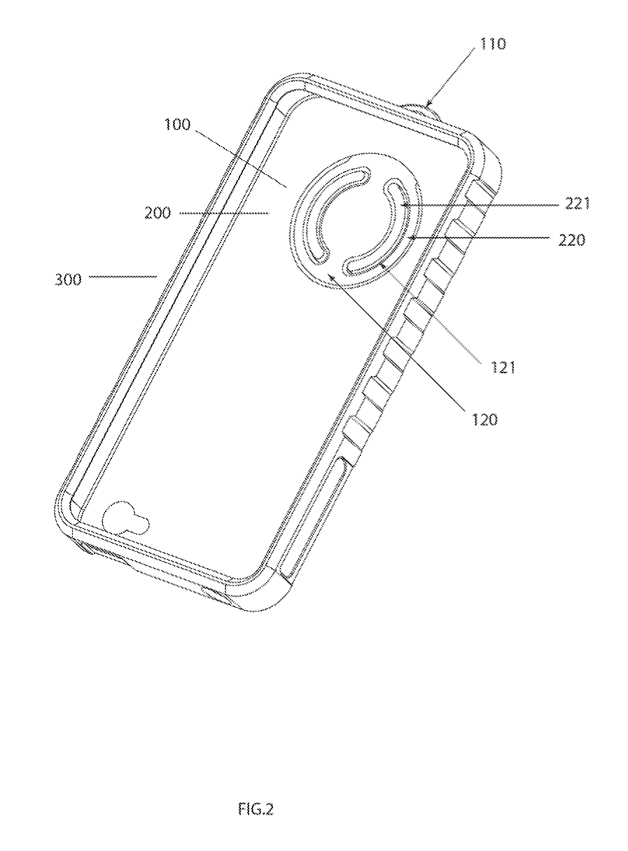

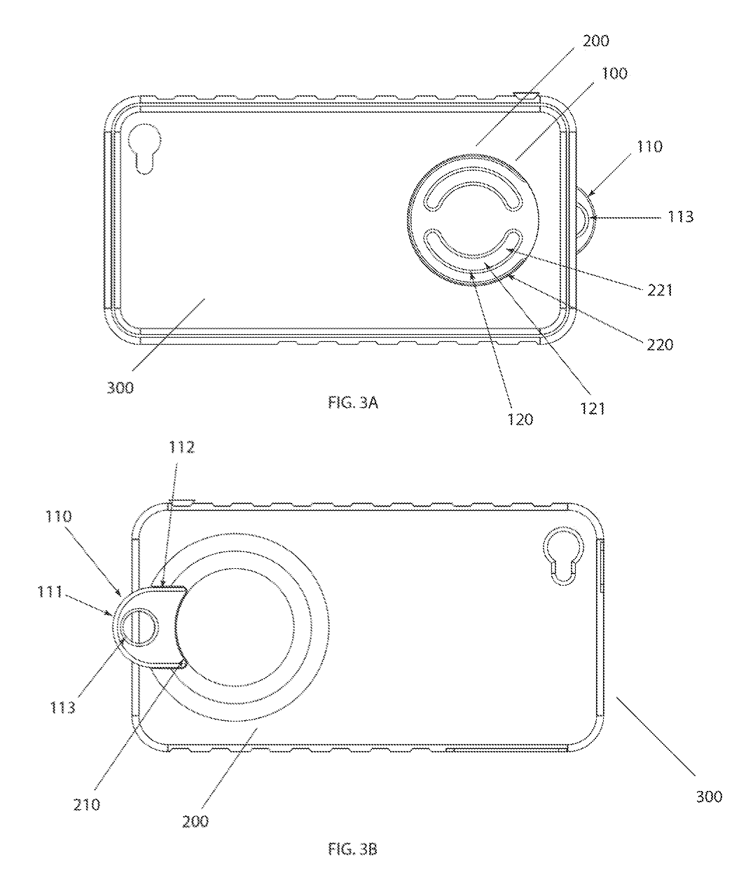

Illustrated in FIGS. 2, 3A and 3B describe an interlocking key attachment tab 100, engaged in corresponding socket 200 formed into a planner base material 300. FIG. 2 is perspective view, FIG. 3A is front view and FIG. 3B is a back view.

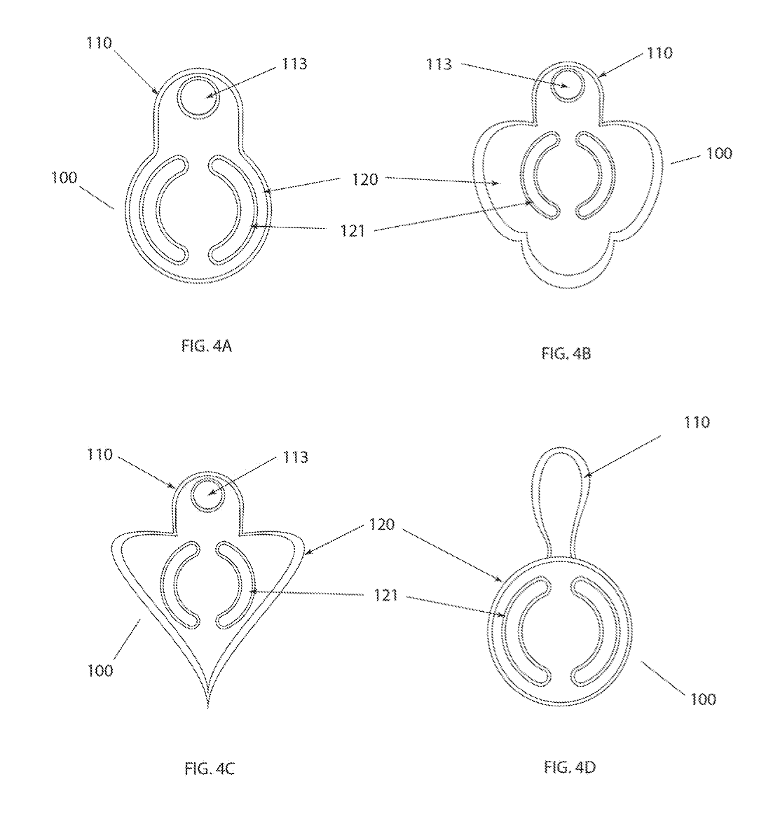

Illustrated in FIGS. 4A through 4D are embodiments of the interlocking key attachment tab 100 including an attachment portion 110 and a body portion 120. An attachment hole 113 formed in the attachment portion 110 and shear lug openings 121 formed in the body portion 120. FIG. 4A shows an interlocking key attachment tab 100 having a round body portion 120. FIG. 4B shows and interlocking key attachment tab 100 having a custom clover shaped body portion 120 and FIG. 4C shows and interlocking key attachment tab 100 having a custom spade shaped body portion 120. FIG. 4D is an interlocking key attachment tab 100 having a body portion 120 formed as a planner shape and the attachment portion 110 formed as a cable or cordage loop.

In view of the foregoing, those having ordinary skill in the relevant art will appreciate the advantages provided by the features of the present disclosure.

It is to be understood that the above mentioned arrangements are only illustrative of the application of the principles of the present disclosure. Numerous modifications or alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

1. An interlocking key attachment tab comprising:
an attachment tab including;
a body portion,
an attachment portion,
a corresponding socket having a bottom and a vertical wall formed in a first side of a planner base material,
the corresponding socket of a size and shape compatible with the body portion,
a slot formed in the vertical wall of the corresponding socket and,
the slot configured to allow the attachment portion to extend through to a second side of the planner base material and the slot smaller than the body portion.

2. The attachment tab of claim 1 wherein, the attachment portion includes a attachment hole.

3. The attachment tab of claim 1 wherein, the attachment tab formed using the same material as the planner base material.

4. The attachment tab of claim 1 wherein, the attachment tab formed using material different from the planner base material.

5. The attachment tab of claim 1 wherein, the body portion is a custom shape.

6. The attachment tab of claim 1 wherein, body portion is one of printed and embossed.

7. The attachment portion of claim 1 wherein, the attachment portion is formed using one of a cable and cordage.

8. A method of using an interlocking key attachment tab comprising:
providing a attachment tab including a body portion and a attachment portion,
providing a corresponding socket having, a bottom surface and a vertical wall, formed in a first side of a planner base material, a slot formed in the vertical wall, the slot configured to allow insertion of the attachment portion but, narrower than the body portion of the attachment tab,
inserting the attachment portion of the attachment tab through the slot from the first side of the planner base material to the second side of the planner base material, and,
pressing the body portion of the interlocking key attachment tab into the corresponding socket.
